(19) United States
(12) Patent Application Publication
(10) Pub. No.: US 2005/0204065 A1
(43) Pub. Date: Sep. 15, 2005

(54) Synchronization method of upnp-based home network

(76) Inventors: Jin-Ho Son, Gwacheon (KR); Min-Seok Kang, Seoul (KR)

Correspondence Address: BIRCH STEWART KOLASCH & BIRCH, PO BOX 747, FALLS CHURCH, VA, 22040-0747, US

(21) Appl. No.: 10/517,825

(22) PCT Filed: Jun. 16, 2003
(86) PCT No.: PCT/KR03/01175

§ 371 Date: Dec. 14, 2004

(51) Int. Cl. G06F 15/16

(52) U.S. Cl. 709/248

(57) ABSTRACT

Synchronization method of an UPnP (Universal Plug and Play)-based home network is disclosed to automatically transfer information of a CP (Control Point) to a different CP. By switching a role of the CP or generating a virtual UPnP device through the CP, information among plural CPs according to user's roaming can be automatically transferred or exchanged, guaranteeing a continuity of an operation. Thus, time for constructing a system can be reduced and user's convenience is maximized.

### TECHNICAL FIELD

The present invention relates to a home network, and in particular to a synchronization method of a UPnP (universal plug and play)-based home network according to roaming.

### BACKGROUND ART

Recently, with the development of information technologies, not only a PC (personal computer) but also various IT products such as a digital television receiver, a PDA and a game board, etc. can be connected to a network as home network devices, and accordingly a home network comes into the spotlight.

In the home network, by connecting home network devices in a house with a topology, the home network devices own data commonly, and a user can perform broadband communication through them. In more detail, a home network in a narrow sense means wire and wireless network equipment connecting home network devices in a house, and a home network in a broad sense includes a middle wear or a service, etc. for integrating/controlling/operating home network devices mutually besides wire and wireless network equipment themselves.

In particular, in order to integrate/control/operate home network devices mutually, a UPnP (universal plug and play) comes to the front presently. The UPnP is a common protocol for making several home network devices having different standard specifications interface mutually. In more detail, by expanding network devices such as various home appliances, a network printer and an Internet gateway to a network on the basis of Internet standard technologies such as a TCP/IP, a HTTP and a XML, the UPnP makes the network devices perform networking mutually.

The UPnP can be implemented on the basis of a standard defined by a UPnP forum (http://www.UPnP.org) according to a UPnP device architecture 1.0 distributed by Microsoft Company. The UPnP forum is an assembly performing a leading role in establishing of UPNP device and service standards and consists of six working groups.

In the meantime, among the working groups, an A/V (audio/video) working group consists of a control point (hereinafter, it is called a CP) as a UPnP device, a media server and a media renderer according to a UPnP AV architecture.

FIG. 1 is a block diagram illustrating a construction of a general UPnP AV architecture.

As depicted in FIG. 1, in a present UPnP AV architecture 1.0 standard, the UPnP AV structure includes a CP 110; a media server 120 for storing useful contents in a home network; and a media renderer 130 as a UPnP device for rendering the contents through the home network.

The present UPnP AV architecture 1.0 standard presents a construction method for constructing the CP 110, the media server 120 and the media renderer 130 as each construction part; and a combo type method for constructing a CP 110 in the media server 120 or the media renderer 130.

According to the construction, in a construction of a home network, a personal computer, a notebook PC and a TV, etc. having a user interface can be constructed as the CP 110.

And, it is also possible to construct plural devices as the CP 110.

For example, when there is a home network construction including a CP (TV), a media server (a UPnP device having a data storage assembly such as a notebook PC or an audio player, etc.) in a living room and there is another CP (TV2) is installed in a bedroom, operation on the basis of the UPnP AV standard will be described.

First, when a user listening to the music in a living room roams to a bedroom, the user cuts connection to the media server 120 and the media renderer 130 by using the CP 110 placed in the living room while roaming to the bedroom.

Afterward, the user searches all AV UPnP devices in another CP (TV2) in the bedroom, obtains information from the media server 120 and the media renderer 130 and listens to that music again.

In more detail, in the conventional art, in order to proceed a task performed by the user in one place in another place, the task has to be stopped, and the user has to obtain information from the media server and media renderer by searching AV UPnP devices again. Accordingly, time delay caused by reconstructing the UPNP devices through the information may occur, and continuity of the task may not be secured.

### TECHNICAL GIST OF THE PRESENT INVENTION

In order to solve the above-mentioned problems, a synchronization method of a UPnP (universal plug and play)-based home network capable of transmitting information of a CP to another CP in a different place automatically by implementing the CP as a UPnP device will be provided.

In a UPnP-based network system performing a roaming function by including at least two CPs, one of the CPs is implemented as a controllable UPnP device.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a construction of a general UPnP AV architecture;

FIG. 2 is an exemplary view illustrating a Device Description XML file in accordance with an embodiment of the present invention;

FIG. 3 is an exemplary view illustrating a XML file of a media server in accordance with an embodiment of the present invention;

FIG. 4 is an exemplary view illustrating a XML file of a media renderer in accordance with an embodiment of the present invention;

FIG. 5 is a flow chart illustrating roaming states in accordance with an embodiment of the present invention; and

FIG. 6 is a flow chart illustrating roaming operations in accordance with an embodiment of the present invention.

### DETAILED DESCRIPTION OF THE INVENTION

In order to describe a technical construction clearly, as an example, an AV architecture will be described in an embodiment of the present invention.

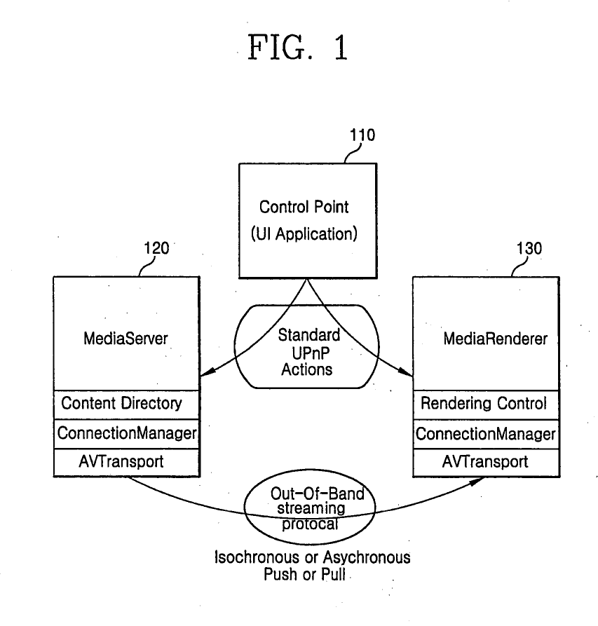

The UPnP AV architecture in accordance with the embodiment of the present invention includes a CP 110, a media server 120 and a media renderer 130 same with a construction in FIG. 1.

In order to play a music file, the CP 110 manages-adjusts an operation of the media server 120 and the media renderer 130 as UPnP devices according to a user's command (play, stop, seek, record, pause) and proceeds following procedures according to a standard.

1) Searching all UPnP AV devices by using a SSDP (simple service discovery protocol) as a UPnP standard protocol, collecting all AV devices on a home network, namely, lists of the media server 120 and the media renderer 130 and storing them in a database are performed.

2) Obtaining a position of a request content is performed by using a Browse( ) command or a search( ) command of a CDS (contents directory service) of the media server 120.

Herein, meta data information of contents objects, a transfer protocol in a <res></res> tag and transport information such as data format, etc. are obtained from the media server 120.

Herein, the CP 110 obtains meta data (result, number returned, total matches, updateID).

3) Through a GetprotocolInfo( ) command of a Connection Manager of the media renderer 130, protocol/format list information, namely, protocol, network, content format and additional Info, etc. are obtained.

For example, there are http-get, *, Mine-type.

Herein, * is a symbol used in an unnecessary case, it is because all devices supporting http is parts of a network using the same IP.

Herein, the CP 110 obtains information such as protocol, network and content format.

4) AVT instance ID information is obtained through PrepareforConnection( ) of a Connection Manager of the media server 120, and Rendering Control Service:: instance ID information is obtained through PrepareforConnection( ) of a Connection Manager of the media renderer 130.

Herein, the CP 110 obtains AVT instance ID and RCS instance ID.

In more detail, obtaining information through the above-mentioned four steps are essential procedures which have to be performed although a CP is changed.

Accordingly, information requested by the CP 110 is information about the media server 120 and the media renderer 130, the CP 110 matches an appropriate protocol with a format by collecting and storing information.

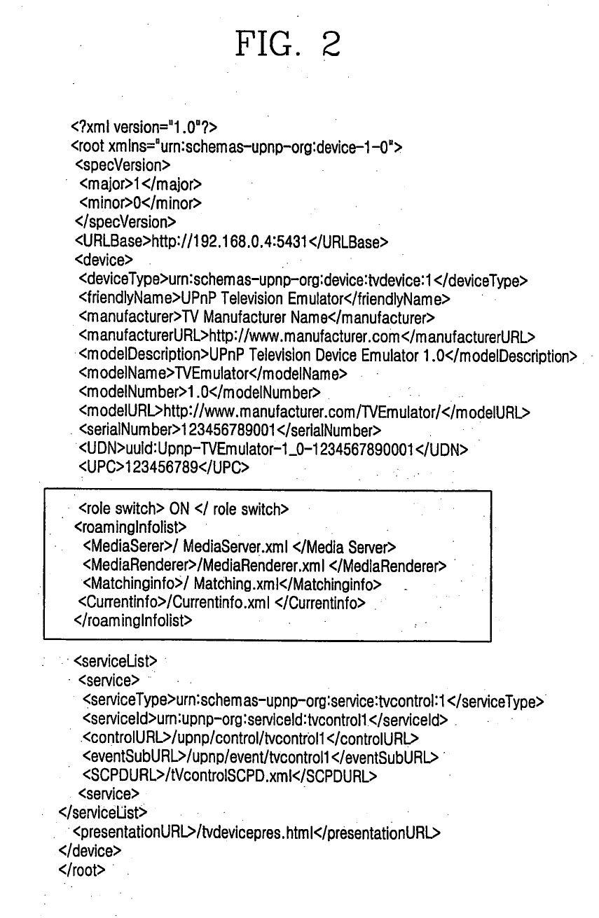

Accordingly, with the basic procedures, a roaming operation according to a user's roaming will be described with reference to accompanying FIGS. 2˜6.

FIG. 2 is an exemplary view illustrating a XML (extensible markup language) file of an improved Device Description.

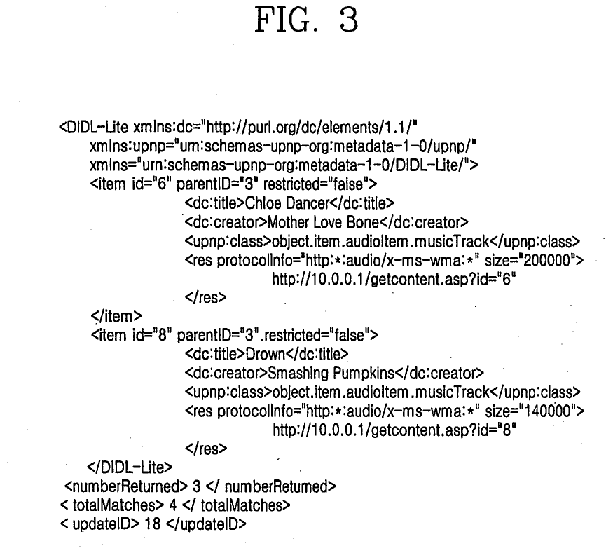

FIG. 3 is an exemplary view illustrating a XML file of the media server 120. In more detail, when the CP 110 instructs a Command: Browse (“2”, “BrowseDirectChildren”, “*”, 0, 2, “+dc:title”), a file is stored in the CP 110.

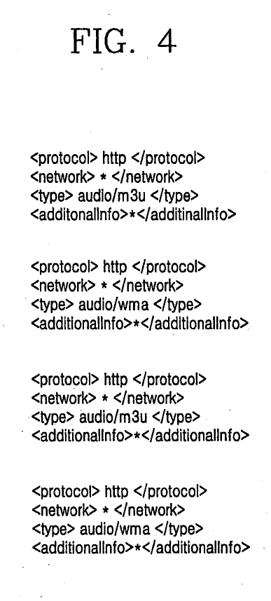

FIG. 4 is an exemplary view illustrating a XML file of the media renderer 130. In more detail, when the CP 110 instructs the Connection Manager of the media renderer 130 to perform a Command: GetProtocolInfo( ) command, a file is stored in the CP 110.

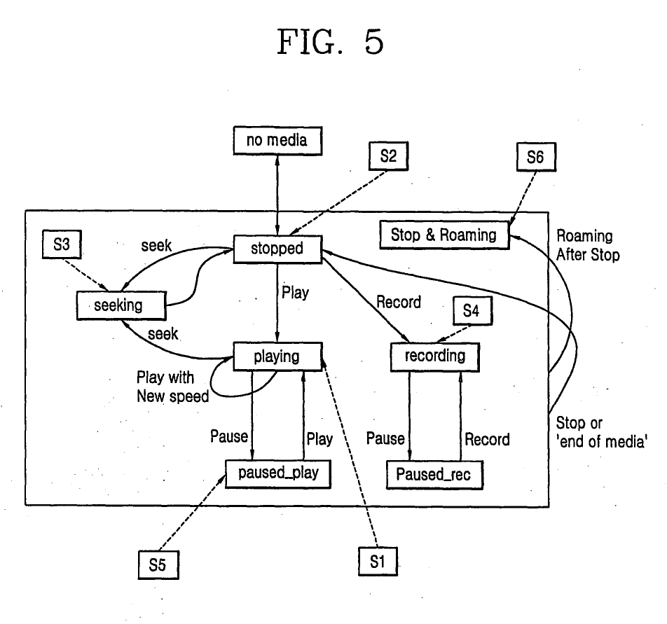

FIG. 5 is a flow chart illustrating roaming states.

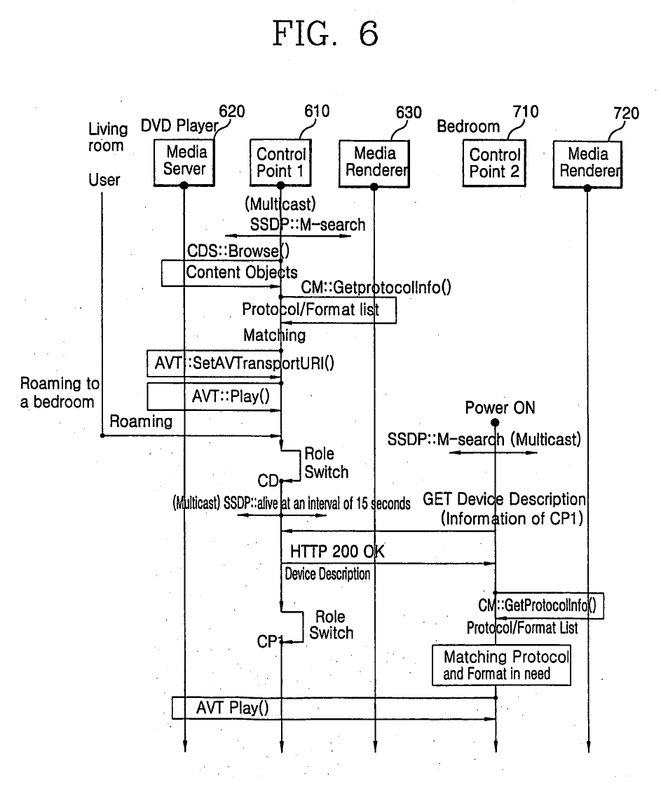

FIG. 6 is an operational flow chart in roaming.

First, when the user listening to the music by using the CP1 610 (as shown at step S1 in FIG. 5) roams to the bedroom, the user presses a roaming key with a remote controller, etc. Herein, the remote controller can be constructed to have a Korean, English, figures and special characters, etc. input function and have a voice recognition function.

Afterward, the state is changed into a stop & roaming state (as shown at step S6 in FIG. 5), the CP1 610 is role-switched into a UPnP device or generates an imaginary UPnP device by a multitask function.

In the present standard, because contents about plural CPs and detecting a CP mutually are not described, the role-switch is performed.

Accordingly, when the CP is role-switched into the UPnP device, it is the same state when the UPnP device is initially connected to the network. In more detail, when the CP is role-switched into the UPnP device, an advertisement message in which it is connected to the network is always sent.

In the standard, the CP1 has to send an advertisement message at an interval of 30 minutes. However, in the role-switch into the UPnP device by the CP according to the useres roaming, 30 minutes are merely for informing connection, it is not appropriate for roaming. Accordingly, in the embodiment of the present invention, it is implemented an advertisement message is sent at an interval of 15 seconds.

In addition, the information to be sent includes a UPnP Device Description URL at a location item in a SSDP (simple service discovery protocol) header and further includes roaming information (described in a box in FIG. 2).

A role switch tag in FIG. 2 indicates a present roaming state, and it is displayed as ON when roaming is proceeded.

According to that, when the user turns-ON power of a CP2 710, the CP2 710 searches a roaming tab in a Device Description and grasps a roaming state of the present UPnP device.

In addition, in the XML storing format of the MediaServer.xml in the RoamingInfolist tag of the CP1 610, as depicted in FIG. 3, information (result, numberreturned, totalMatches, updateID) obtained by performing a browse( ) function are stroed.

And, as depicted in FIG. 4, the MediaRenderer.xml stores four information (protocol, Network, Content Format, additionalInfo) as a XML format.

In addition, MatchingInfo, protocol and data format mutually matched in the CP1 610 are stored, the MatchingInfo is constructed so as to be dependent.

Accordingly, when the user operating the media server 610 and the media renderer 630 on the basis of the CP1 610 roams and turns-ON the CP2 710, the CP2 710 observes a multicast address and a port by the standard.

Afterward, the CP1 610 role-switched into the UPnP device is contacted to the network, it is inputted to a control cache, namely, a device list.

Afterward, the CP2 710 checks a <role-switch> tag of a Description Device Description as shown in FIG. 2, when a present role-switch state is ON, it is judged the CP1 610 is role-switched into the UPnP.

Afterward, the CP2 710 checks a <roamingInfolist>, obtains information from the media server 120 and the media renderer 130 and stores them.

In addition, the CP2 710 stores matching information of the media server 620 and the media renderer 630 and ITEM information in which the user listens or watches at now as a XML format so as to be dependent.

Accordingly, after checking the information of the media renderer 720 in the living room, when they are the same protocol and data format with those of the media renderer 630 of the CP1 610, although the user roams from the living room to the bedroom, the user can use the same contents promptly.

When the protocol and the data format of the media renderer 720 are not same with those of the media renderer 630 (matching information is not coincided with each other), the CP2 710 is re-operated by re-matching with information obtained from the media server according to information of the media renderer 720 in the bedroom.

In addition, when the user presses a roaming complete key after roaming, role-switch is performed as <role switch> OFF </role switch> in the Device Description.

According to that, the CP1 610 periodically checks a state of the role switch tag, when the tag is switched into OFF, the CP1 610 role-switched into the UPnP device is role-switched again into the CP.

As described-above, when the user performing a certain operation in the living room inputs a roaming key with the remote controller, etc. while roaming to the bedroom, the CPl 610 is role-switched into the UPnP device or generates an imaginary UPnP device, and presently constructed-media server and media renderer information are broadcast to the network. Afterward, when the user turns-ON power of the CP2 710, the CP2 710 obtains the information of the CP1 610 from the network and re-performs the operation performed in the living room.

As described-above, in the present invention, by transmitting information between CPs automatically according to roaming of the user, it is possible to secure continuity of the operation and reduce system construction time, and accordingly it is convenient for the user.

### INDUSTRIAL APPLICABILITY

In the present invention, when a user performing a certain operation roams from a place to another place, by transmitting information of a CP automatically to another CP, it is possible to secure continuity of the operation and reduce time required for constructing another UPnP device. The present invention can be used for not only AV CPs (control point) but also CPs of other working groups.

1. In a network system based on a UPnP (universal plug and play) performing a roaming function by including at least two CPs (control point), wherein a synchronization method of a UPnP-based home network implements a UPnP device controllable by using one of the CPs.

2. The method of claim 1, wherein the CP performs a CP function and a UPnP device function simultaneously by generating an imaginary UPnP device.

3. The method of claim 1, wherein a UPnP device is generated by role-switching the CP.

4. The method of claim 3, wherein information about the CP before role-switching is transmitted through an advertisement message of the UPnP device.

5. The method of claim 4, wherein the advertisement message includes roaming state information of the UPnP device.

6. The method of claim 1, wherein the CP is constructed to be role-switched into a UPnP device by corresponding to a key input of a user according to roaming.

7. The method of claim 6, wherein the key input includes Korean, English, figures and special characters input function and a voice recognition function.

8. The method of claim 1, wherein the CP classifies whether a message is an advertisement message of a UPnP device or a roaming message according to role-switch of a CP by checking a roaming state in Device Description, information of a media server and a media renderer and a presently user selecting item.

9. The method of claim 1, wherein the CP transmits a roaming message periodically for a certain time less than time recommended by a standard and is constructed to be role-switched again into a CP.

10. The method of claim 1, wherein the synchronization method further includes:
turning-on power of a CP to be used by a user after roaming;
storing information of a media server and a media renderer by checking a present roaming state through the CP; and
judging correspondence of protocols and data formats of the media renderer before/after role-switch and finishing the operation.

11. The method of claim 10, wherein the operation is finished when the protocols and the data formats are corresponded, when the protocols and the data formats are not corresponded, the operation is finished after matching-corresponding the media server and the media renderer.

12. In a UPnP (universal plug and play)-based home network system including a CP (control point), a media server and a media renderer, wherein the CP performs a UPnP standard roaming function by being role-switched into a UPnP device.

13. The method of claim 12, wherein the CP is role-switched into a UPnP device by corresponding to a key input according to user's roaming.

14. The method of claim 12, wherein the CP transmits CP information before role-switch by using an advertisement message of a SSDP (simple service discovery protocol) of a UPnP device.

15. The method of claim 12, wherein the CP is constructed to provide a roaming state in a Device Description; provide information of the media server and the media renderer; provide an item presently selected by the user; and classify whether a message is an advertisement message of a UPnP device or a roaming message according to role-switch of the CP.

16. The method of claim 15, wherein the CP transmits a roaming message periodically for a certain time less than time recommended by a standard and is constructed to be role-switched again into a CP.

17. In a UPnP (universal plug and playbased home network system including a CP (control point), a media server and a media renderer, the CP simultaneously performs a CP function and a UPnP device function by generating an imaginary UPnP device.

18. The method of claim 17, wherein the CP is constructed to be role-switched into the UPnP device by corresponding to a key input according to a user's roaming.

19. The method of claim 17, wherein the CP transmits CP information before role-switch by using an advertisement message of a SSDP (simple service discovery protocol) of the UPnP device.

20. The method of claim 17, wherein the CP classifies whether a message is an advertisement message of a UPnP device or a roaming message according to role-switch of a CP by transmitting information such as a roaming state in Device Description, information of a media server and a media renderer and a presently user selecting item periodically for a certain time less than time recommended by a standard.
